(19) United States
(12) Patent Application Publication
(10) Pub. No.: US 2022/0198499 A1
(43) Pub. Date: Jun. 23, 2022

(54) Referral tracking application and web-based service

(71) Applicant: Joseph Jablonski, Springfield, VA (US)

(72) Inventor: Joseph Jablonski, Springfield, VA (US)

(21) Appl. No.: 17/554,309

(22) Filed: Dec. 17, 2021

Related U.S. Application Data
(60) Provisional application No. 63/126,776, filed on Dec. 17, 2020.

(51) Int. Cl. G06Q 30/02; G06Q 20/02

(52) U.S. Cl. CPC G06Q 30/0214; G06Q 20/02; G06Q 30/0281

(57) ABSTRACT

An application for a mobile device and/or a web-based service capable of tracking and compiling referrals from business to business and individual to business, as well as compensating users for providing referrals.

### CROSS REFERENCE TO RELATED APPLICATIONS

Not applicable.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

### Field of the Invention

The invention is an application for a mobile device and/or a web-based service capable of tracking and compiling referrals from business to business and individual to business, as well as compensating users for providing referrals.

### Background of the Invention

Multiple applications, websites and similar algorithms exist through which customers may input data reviewing or referring different providers of goods and services based on their experience with the provider and the product. Home Advisor, Angie's List and Yelp are examples. These services require a user to fill out automated forms and/or input free-form text rating their experiences with service businesses such as restaurants, electricians, plumbers, hotels, short-term rental properties, etc. These types of services operate as middlemen between users and businesses.

Such services typically compile and aggregate the input data to create a rating system that allows users to quickly see an average communicated as a number or star rating associated with a given service provider. The individual user typically provides his or her feedback as a free service and receives informal consideration in the form of access to other user's data. An unintended consequence of the known system is that users are more likely to take the time to input a review when they have had a particularly memorable experience, good or bad. Further, studies have consistently shown that users are most likely to create a rating when they are dissatisfied or angry.

However, there currently exists no mobile application capable of actively tracking a user's referrals for vendors or providers in real time and saving those referrals to a database which can be accessed on an individual basis or grouped with other users' data to create a searchable database by third parties to access the identities of businesses referred by both business and individual customers. There also exists no such application that provides a payment scheme for users who refer third parties to given businesses.

What is needed is a mobile application and/or a web-based service that allow for tracking, compilation and compensation to members based on their referrals of businesses to third parties.

### DETAILED DESCRIPTION OF THE INVENTION

The invention is a mobile application and/or web-based service for generating references for user's businesses. User accounts may be either for an individual or a business user, and can be created by inputting the new client's personal information such as email address, tax identification number, etc.

The mobile application and web-based platforms will allow users to interface with a hosted database containing information for all other users, including vendor businesses. As users provide referrals for businesses to third parties, those referrals will be logged by the invention algorithm and stored in related databases hosted on servers. As more referrals are made, the amount of searchable reference data gathered will enable users to compare vendors and make informed choices both about whom to hire and whom to refer.

Since all individuals and businesses use vendors on a constant basis, the opportunity exists to refer vendor businesses to colleagues, acquaintances and other known third parties. At present, people and businesses do so on an ad-hoc basis, either directly, through social media or message boards or similar communication methods. A registered user of the inventive service will be able to provide references to third parties based on that proprietary information. Further, the service will offer a feature whereby users making referrals are compensated through the service, ideally by linking to the user's own payment app through a service such as Paypal, Zelle or Venmo. The invention will thus provide both individuals and business users with a supplemental income stream for performing a service, the referral of vendors to third parties, that the user would have performed for free anyway.

In a preferred embodiment, the inventive service will offer a basic user account for free, with a premium account being offered for a monthly or annual fee. A premium account for vendors will allow their business to be featured, appear higher on a search list, or even be exclusive within a certain geographic area. In one embodiment, the size of the area of exclusivity could be related to the size of the fee payment.

In practice, a user will be able to track a given vendor's job performance in real time by inputting information or responding to prompts through the application, including:
Customer contact,
Schedule of estimate for work time and cost,
Work schedule,
Work completion,
Money earned, including as a percentage of job cost, and
Compensation paid out monthly

The application may include specific features for types of a service businesses such as restaurants, hotels and rental properties to facilitate ease of use among users who generally focus on one such area.

The disclosures herein, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable equivalents.

I claim:

1. A method of using a software application for use on a mobile device, connected by the internet to a server(s) with a database(s) containing a list of vendors and business references, comprising the steps:
1. prompting a user to establishes a user account;
2. establishing the user account by prompting the user to input personal or business information;
3. optionally prompting the user to input vendor specific information if such user intends to offer goods or services through the application;
4. providing the user access to lists of vendors in a geographic area;
5. providing a means of choosing a vendor and tracking vendor performance through the application;
6. providing a means of referring a vendor to a third party;
7. gathering and storing data from the user on vendors chosen, vendors referred, and vendor performance; and
8. aggregating stored data and making such data searchable to all users.

2. The method of use of claim 1, wherein the application determines a payment amount for the user's choice to refer a vendor to a third party and makes such payment through a third-party payment application.

3. The method of use of claim 1, wherein step 3 also includes the offer of a payment to a user inputting vendor information to buy a premium account.

4. The method of claim 3, wherein the user may purchase a premium account granting the user exclusivity of reference within a preset geographic area.

5. The method of claim 1, wherein the vendor performance data of step 7 comprises:
Customer contact,
Schedule of estimate for work time and cost,
Work schedule,
Work completion,
Money earned, including as a percentage of job cost, and
Compensation paid out monthly.
